(19) United States
(12) Patent Application Publication
(10) Pub. No.: US 2021/0278717 A1
(43) Pub. Date: Sep. 9, 2021

(54) ELECTRONIC DEVICE

(71) Applicant: Innolux Corporation, Miao-Li County (TW)

(72) Inventor: Yi-Hsin Chen, Miao-Li County (TW)

(73) Assignee: Innolux Corporation, Miao-Li County (TW)

(21) Appl. No.: 17/190,419

(22) Filed: Mar. 3, 2021

(30) Foreign Application Priority Data
Mar. 5, 2020 (CN) 202010147548.4

(51) Int. Cl. G02F 1/13363; G02F 1/1335

(52) U.S. Cl. CPC G02F 1/13363; G02F 1/133565; G02F 2413/13; G02F 2413/14; G02F 1/133528

(57) ABSTRACT

An electronic device is provided. The electronic device includes a first substrate and a second substrate. The second substrate is disposed opposite to the first substrate. A light control layer is disposed between the first substrate and the second substrate, and the light control layer includes a first optical axis. A negative phase retardation layer is disposed between the first substrate and the second substrate. The negative phase retardation layer includes a second optical axis. The first optical axis and the second optical axis are parallel to each other.

### CROSS-REFERENCE TO RELATED APPLICATION

This application claims the priority benefit of China application serial no. 202010147548.4, filed on Mar. 5, 2020. The entirety of the above-mentioned patent application is hereby incorporated by reference herein and made a part of this specification.

### BACKGROUND

### 1. Technical Field

The disclosure relates to electronic devices, and particularly relates to electronic devices for image display.

### 2. Description of Related Art

Image display devices have been widely used. A variety of image display electronics devices have been proposed along with the development of technology, among which liquid crystal display devices are one of the widely used. Image display technology has been developed over the years and is no longer limited to displaying on a flat surface. In other words, the display panel displaying images can be curved, which meets a wide range of needs.

In a curved image display panel, two substrates of a liquid crystal display device, for example, may display an image when curved. However, due to the optical characteristics, an equivalent slow optical axis with birefringence effect are generated when the two substrates become curved, and the equivalent slow optical axis become optical axes on the substrate surface. Due to inconsistent changes in the optical axes of the two substrates, light leakage is generally resulted, degrading the image display quality.

How to reduce light leakage needs to be taken into consideration in product development.

### SUMMARY

In an embodiment, the disclosure provides an electronic device. The electronic device includes a first substrate and a second substrate. The second substrate is disposed opposite to the first substrate. A light control layer is disposed between the first substrate and the second substrate, and the light control layer includes a first optical axis. A negative phase retardation layer is disposed between the first substrate and the second substrate. The negative phase retardation layer includes a second optical axis. A projection of the first optical axis and a projection of the second optical axis on a tangent plane of the first substrate are parallel to each other.

In an embodiment, the disclosure provides an electronic device. The electronic device includes a first substrate and a second substrate. The second substrate is disposed opposite to the first substrate. A light control layer is disposed between the first substrate and the second substrate, and the light control layer includes a first optical axis. A positive phase retardation layer is disposed between the first substrate and the second substrate. The positive phase retardation layer includes a third optical axis. A projection of the first optical axis and a projection of the third optical axis on a tangent plane of the first substrate are parallel to each other.

In an embodiment, the disclosure provides an electronic device. The electronic device includes a first substrate and a second substrate. The second substrate is disposed opposite to the first substrate. A light control layer is disposed between the first substrate and the second substrate, and the light control layer includes a first optical axis. A positive phase retardation layer is disposed between the first substrate and the second substrate. The positive phase retardation layer includes a third optical axis. A projection of the first optical axis and a projection of the third optical axis on a tangent plane of the first substrate are perpendicular to each other.

### BRIEF DESCRIPTION OF THE DRAWINGS

The accompanying drawings are included to provide a further understanding of the disclosure, and are incorporated in and constitute a part of the disclosure. The drawings illustrate embodiments of the disclosure and, together with the description, serve to explain the principles of the disclosure.

FIG. 1 is a schematic diagram of a cross-sectional structure of a general display panel disclosed in the disclosure in a curved state.

FIG. 2 is a schematic diagram of a cross-sectional structure of a stacked layer display panel according to an embodiment of the disclosure.

FIG. 3 is a schematic diagram of a trajectory of a polarization state on a polarization sphere, in a direction of normal viewing angle, of a monochromatic incident light passing through a display panel according to an embodiment of the disclosure.

FIG. 4 is a schematic diagram of a degree of light leakage according to the viewing angle position, based on to the configuration of FIG. 3, according to an embodiment of the disclosure.

FIG. 5 is a schematic diagram of a trajectory of a polarization state, on a polarization sphere, of a monochromatic incident light passing through a display panel according to an embodiment of the disclosure.

FIG. 6 is a schematic diagram of a degree of light leakage according to the viewing angle position, based on the configuration of FIG. 5, according to an embodiment of the disclosure.

FIG. 7 is a schematic diagram of the trajectories of polarization states on a polarization sphere of the incident light including red light, green light, and blue light passing through a display panel according to an embodiment of the disclosure.

FIG. 8A to FIG. 8C are schematic cross-sectional structural diagrams of a liquid crystal display device according to various embodiments of the disclosure.

### DESCRIPTION OF THE EMBODIMENTS

Herein, some embodiments of the disclosure are described with reference to the accompanying drawings. In fact, various different modifications may be used in these embodiments, and the disclosure is not limited to the embodiments herein. The same reference symbols or numerals in the drawings are used to indicate the same or similar components.

The disclosure can be understood by referring to the following detailed description in conjunction with the accompanying drawings. It should be noted that in order to make it easy for the readers to understand and for the concise the diagrams, only a part of the electronic device is drawn in the various diagrams in the disclosure. Moreover, the specific components in the drawings are not drawn according to actual scale. In addition, the number and size of each component in the drawings are only for illustration, and are not used to limit the scope of the disclosure.

Certain terms are used throughout the specification and appended claims of the disclosure to refer to specific components. Those skilled in the art should understand that electronic device manufacturers may refer to the same components by different names. The disclosure does not intend to distinguish between components that have the same function but different names. In the following specification and claims, terms such as “including”, “containing”, and “having” are open-ended terms, so should be interpreted as meaning “including but not limited to . . . .” Therefore, when the terms “including”, “containing” and/or “having” are used in the description of the disclosure, these terms specify the existence of corresponding features, regions, steps, operations and/or components, but do not exclude the existence of one or more corresponding features, regions, steps, operations and/or components.

The directional terms mentioned in the disclosure, for example: “upper”, “lower”, “front”, “rear”, “left”, “right” and like are only directions with reference to the accompanying drawings. Therefore, the directional terms used are for illustration, but not to limit the disclosure. In the drawings, each drawing shows the general features of the methods, structures and/or materials adopted in specific embodiments, but should not be construed as defining or limiting the scope or nature covered by the embodiments. For example, for clarity, the relative size, thickness, and position of each layer, region, and/or structure may be reduced or enlarged.

When a corresponding component such as a film layer or region is referred to as being “on another component”, it may be directly on the other component, or there may be other components between the two. On the other hand, when a component is referred to as being “directly on another component”, there is no component between the two. In addition, when a component is referred to as being “on another component”, the two have a vertical relationship in the top view direction, and the component may be above or below the other component, and the vertical relationship depends on the orientation of the device.

It should be understood that when a component or film layer is referred to as being “connected to” another component or film layer, it may be directly connected to this other component or film layer, or there may be a component or film layer inserted in between. When a component is referred to as being “directly connected” to another component or film, there is no component or film inserted between the two. In addition, when a component is referred to as being “coupled to another component (or to a variant thereof)”, it may be directly coupled to this other component, or indirectly coupled (for example, electrically coupled) to this other component through one or more components.

The terms “about”, “substantially” or “approximately” are generally interpreted as being within 20% of a given value or range, or interpreted as being within 10%, within 5%, within 3%, within 2%, within 1%, within 0.5% or less of a given value or range.

The ordinal numbers used in the specification and claims, such as the terms “first”, “second” and the like, to qualify a component do not imply or represent that the component or components are preceded with any ordinal numbers, nor do they represent the order of a certain component and another component, or the order in the manufacturing method, and are used only so as to clearly distinguish a component with one name from another component with the same name. Different terms may be used in the claims and the specification, and accordingly, a first component in the specification may be a second component in the claims.

The electronic device disclosed in the disclosure may include, for example, a display device, an antenna device, a sensing device, a touch display, a curved display, a free shape display, and a tiled display. The tiled display may also be a bendable or flexible tiled device, but the disclosure is not limited thereto.

The electronic device may include, for example, a light emitting diode, liquid crystal, fluorescence, phosphor, other suitable display media, or a combination of the foregoing, but the disclosure is not limited thereto. The light-emitting diode may include, for example, an organic light-emitting diode (OLED), an inorganic light-emitting diode (LED), a sub-millimeter light-emitting diode (mini LED), a micro LED, a quantum dot (QD) light emitting diode (QDLED), a quantum light emitting diode (QLED), other suitable materials, or any combination of the above, but the disclosure is not limited thereto. The antenna device may be, for example, a liquid crystal antenna, but the disclosure is not limited thereto. It should be noted that the electronic device may be any arbitrary arrangement and combination described above, but the disclosure is not limited thereto. In addition, the appearance of the electronic device may be rectangular, circular, polygonal, a shape with curved edges, or other suitable shapes. An electronic device may have peripheral systems such as a drive system, a control system, a light source system, a rack system, and the like, so as to support a display device or an antenna device.

The following description takes a display device as an example.

Some embodiments are given below for illustration, but the disclosure is not limited to these embodiments. In addition, there are situations where the embodiments mentioned may be combined.

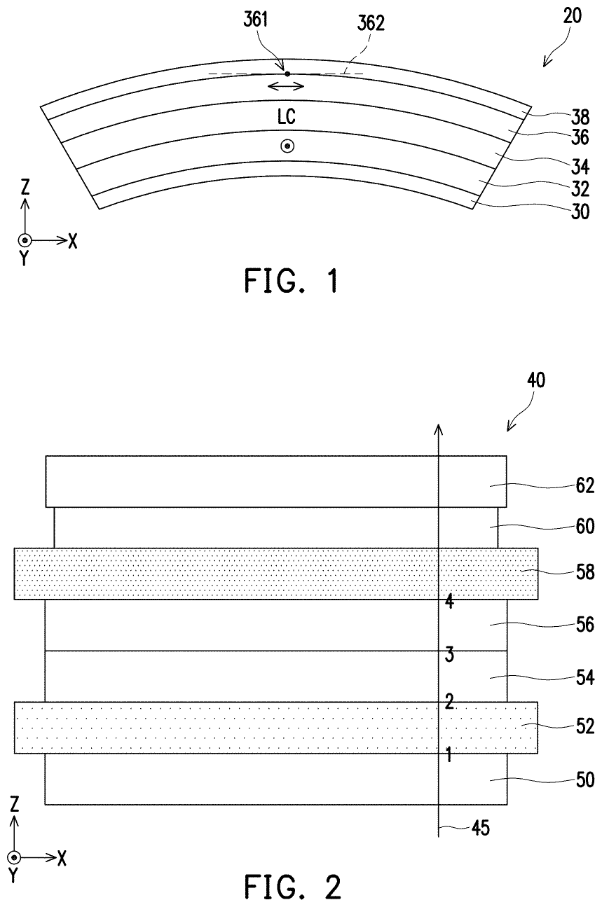

FIG. 1 is a schematic diagram of a cross-sectional structure of a general display panel disclosed in the disclosure in a curved state. Referring to FIG. 1, an electronic device 20 may be, for example, a liquid crystal display device, which allows the display panel to display an image in a curved state.

A stacked layer of the electronic device 20 may include, for example, a polarization layer 30, a substrate 32, a light control layer 34, a substrate 36, and a polarization layer 38. The light control layer 34 may be configured to control the amount of light passing through, and may be, for example, a liquid crystal layer. The substrate 32 and the substrate 36 may also include multiple photo structure layers and control circuits (not shown) for displaying images, which are not described in detail here.

The structure of FIG. 1 of the disclosure is to show that in a dark state, light leakage occurs after a background light source (not shown) in the electronic device 20, a curved panel, passes through the curved panel for example, which may affect display quality. The substrate 32 and the substrate 36 are squeezed or stretched when curved, such that the substrate 32 and the substrate 36 have birefringent optical characteristics. For example, after the substrate 32 and the substrate 36 become curved, the substrate 32 and the substrate 36 may each generate at least one optical axis in a corresponding area perpendicular to a direction, such as a z direction, of the substrate 32 and the substrate 36. The optical axis of the substrate 32 and the optical axis of the substrate 36 are perpendicular to each other on a tangent plane of the substrate 36, as indicated by an arrow in the figure. The disclosure indicates only one perpendicular state of the optical axis; there may also be perpendicular states in other directions, and the disclosure is not limited thereto. In manufacturing, whether two geometric objects are perpendicular or parallel to each other depends on the accuracy of the manufacturing technology. In one embodiment, the disclosure indicates that an absolute value of an included angle between two optical axes perpendicular to each other has an allowable range, for example, between 80 and 100 degrees. The disclosure also indicates that an absolute value of the included angle between two optical axes parallel to each other also has an allowable range, for example, less than or equal to 10 degrees. The disclosure defines the tangent plane as a plane, when the electronic device 20 is a curved panel, tangent to the substrate through any point selected on the substrate. For example, as shown in FIG. 1, a plane 362 is a tangent plane, tangent to the substrate 36 through a point 361. If the electronic device 20 is a substantially flat panel, the plane perpendicular to the substrate normal is the aforementioned tangent plane. After the substrate 32 and the substrate 36 become curved, the substrate 32 and 36 have birefringent optical characteristics. Based on optical principles, the polarization state of the incident light passing through the substrate 32 and the substrate 36 will be changed. In addition, the light control layer 34 will also change the polarization state of the incident light. After the incident light passes through the substrate 36, the polarization state will change, and after passing through the polarization layer 38, light leakage occurs. There are many reasons for the light leakage, and, according to the study of the disclosure, the degree of light leakage caused by the structure shown in FIG. 1 is not to be ignored.

After studying the mechanism of light leakage, the disclosure proposes a method of adding a phase retardation layer, which can make the polarization state of light after passing through the substrate be as similar as or close to the polarization state of the initial design as much as possible, in which the light is absorbed by the polarization layer after the light passes through the substrate, reducing light leakage.

FIG. 2 is a schematic diagram of a cross-sectional structure of a part of a stacked layer display panel in an electronic device 40 according to an embodiment of the disclosure. Referring to FIG. 2, a part of the stacked layer of the electronic device 40 of the disclosure may include a first polarization layer 50, a first substrate 52, a light control layer 54, a phase retardation layer 56, a second substrate 58, a compensation film 60, and a second polarization layer 62. The second substrate 58 is disposed opposite to the first substrate 52. The phase retardation layer 56 and the light control layer 54 are disposed between the first substrate 52 and the second substrate 58, but there is no need to be in order. The light control layer 54 and the phase retardation layer 56 may be disposed between the light control layer 54 and the second substrate 58, or the phase retardation layer 56 may be disposed between the light control layer 54 and the first substrate 52. The light control layer 54 may include a first optical axis (not shown). The compensation film 60 may be configured according to actual needs. The compensation film 60 may be, for example, a compensation film of the electronic device 40 under a large viewing angle. The light control layer 54 of the disclosure is configured to control the gray scale of the incident light under normal display operation, and may be a liquid crystal layer including liquid crystal material, for example. The alignment of the liquid crystal layer may be, for example, a horizontal alignment, for an Azimuthal Anchoring Switch (AAS) structure or In-plane Switch (IPS) structure, for example, but the disclosure is not limited thereto, which may also be applied to a Twist Nematic (TN) or vertically aligned liquid crystal.

The phase retardation layer 56 may be configured to adjust the polarization state change caused by the light control layer 54, such that the polarization state of the incident light 45 before passing through the second substrate 58 and the polarization state of the incident light 45 after passing through the first substrate 52 are the same or as close as possible. The first substrate 52 and the second substrate 58 may be birefringent materials, or in special cases, have birefringent optical characteristics. For example, when curved, the first substrate 52 and the second substrate 58 turn into materials with birefringent optical characteristics. The optical axis of the first substrate 52 and the optical axis of the second substrate 58 may be perpendicular to each other on the corresponding tangent plane. In this way, the polarization state of the incident light 45 after passing through the second substrate 58 can return to the original polarization state or as close to the original polarization state as possible. The original polarization state in the disclosure refers to the polarization state of the incident light 45 after passing through the first polarization layer 50; the incident light may be locked by the second polarization layer 62 when passing through the second polarization layer 62, effectively reducing light leakage. The mechanism by which the phase retardation layer 56 reduces light leakage may be more clearly seen from the trajectory of the polarization state on the polarization sphere, also referred to as Poincare Sphere.

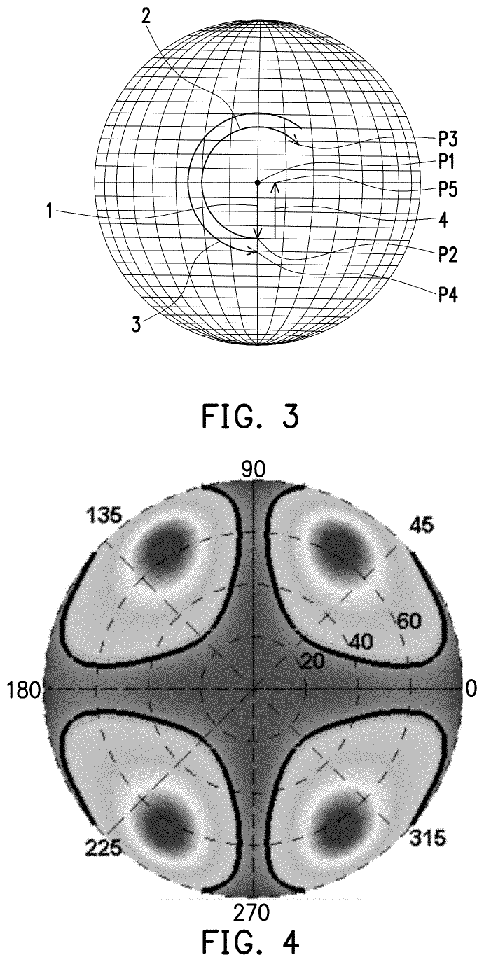

FIG. 3 is an embodiment of the disclosure. The electronic device 40 further includes a working area (not shown), which may be, for example, a display area in a liquid crystal display device. FIG. 3 is a schematic diagram of the trajectory of the polarization state on a polarization sphere, in a direction such as the Z direction shown in FIG. 2 of normal viewing angle at a certain point in the working area, of the incident light 45 passing through a display panel, where the incident light 45 is exemplified by a single color, for example, a green color. Referring to FIG. 2 and FIG. 3, the phase retardation layer 56 may be a negative phase retardation layer, and the negative phase retardation layer may include a negative-type material with optical anisotropy; the negative-type material is defined as having an extraordinary ray refractive index (ne) less than the ordinary ray refractive index (no). In other words, the difference between the extraordinary refractive index and the ordinary refractive index is defined as Δn, which is also called the modulated refractive index, given by a mathematical relation Δn=ne−no. In the disclosure, the negative-type material indicates Δn <0 and the positive-type material indicates Δn >0; both are, however, only examples of the disclosure, and may be defined using three-dimensions. The phase retardation layer 56 may include a second optical axis (not shown), in which the projection of the first optical axis and the projection of the second optical axis on the tangent plane of the first substrate 52 are substantially parallel to each other, for example, the projection of the first optical axis and the projection of the second optical axis on the tangent plane (not shown) of the first substrate 52 are both parallel to an X axis, selecting a suitable phase retardation value of the phase retardation layer 56. The suitable phase retardation value may be a negative value of the phase retardation layer close to the light control layer 54, or may be a negative value of the phase retardation layer close to the light control layer 54 minus an integer multiple of the wavelength of the incident light 45. For example, if the phase retardation value of the light control layer 54 is 360 nanometers, the suitable phase retardation value of the phase retardation layer 56 is substantially equal to −360-n*λ nanometers or close to −360-n*λ nanometers, where n is an integer value greater than or equal to zero, and λ is the wavelength of the incident light 45, but the disclosure is not limited thereto.

Referring to FIG. 2 and FIG. 3, after the incident light 45 passes through the first polarization layer 50, the incident light 45 reaches a position marked 1 in FIG. 2 and becomes the original polarization state described in the disclosure, such as a linear polarization, which is located at a position P1 on the polarization sphere at this time. When the incident light 45 passes through the first substrate 52 with birefringent optical characteristics, when viewed on the polarization sphere, the polarization state may move to a position P2 along a trajectory 1 in FIG. 3, for example, and the incident light 45 may reach a position marked 2 in FIG. 2 at this time. Next, the incident light 45 passes through the light control layer 54; when viewed on the polarization sphere, the polarization state may move to a position P3 along, for example, a trajectory 2 in FIG. 3; at this time, the incident light 45 may reach a position marked 3 in FIG. 2. Next, the incident light 45 passes through the phase retardation layer 56. When viewed on the polarization sphere, the reference point may move to a position P4 along, for example, a trajectory 3 in FIG. 3; at this time, the incident light 45 reaches a position marked 4 in FIG. 2. Here, in a direction of a normal viewing angle, the trajectory 2 on a polarization sphere corresponds to a transition of a polarization state of the incident light 45 passing through the light control layer 54, the trajectory 3 on the polarization sphere corresponds to a transition of a polarization state of the incident light 45 passing through the negative phase retardation layer 56, and the trajectory 3 may take a reverse turn relative to the trajectory 2. In an embodiment of the disclosure, position P4 and position P2 may be the same position or close to the same position on the polarization sphere. In other words, the suitable phase retardation value designed by the phase retardation layer 56 could make the polarized state of the incident light 45 return to a position close or equal to the polarization state at position P2. When the incident light 45 passes through the second substrate 58 with birefringent optical characteristics, when viewed on the polarization sphere, the reference point may move to the position P5 along, for example, a trajectory 4 in FIG. 3; at this time, the incident light 45 may reach between the second substrate 58 and the compensation film 60. The trajectory 4 may take a reverse turn relative to the trajectory 1. In an embodiment of the disclosure, position P4 and position P5 may be the same position or close to the same position on the polarization sphere. In other words, the suitable phase retardation value designed by the phase retardation layer 56 could make the polarized state of the incident light 45 return to a position close to or equal to the polarization state at the position at position P1. When the incident light 45 passes through the second polarization layer 62, light leakage can be reduced. The trajectory 1, the trajectory 2, the trajectory 3, and the trajectory 4 in FIG. 3 are only schematic diagrams of one of the embodiments of the disclosure. In an embodiment of the disclosure, the trajectory 3 may also return to position P4 after moving a complete round or more. In other words, before the incident light 45 enters the second substrate 58, the reverse turn that the trajectory 3 takes relative to the trajectory 2 may be without round or an integer round in trajectory greater than zero. That is to say, when the trajectory 2 takes a reverse turn and the followed by the trajectory 3 moving to position P4 or position P2, it may be said that the trajectory 3 takes a reverse turn relative to the trajectory 2 without round. In other words, the trajectory 3 and the trajectory 2 add up to zero round. In another embodiment, when the trajectory 3 first passes through position P4 or position P2 from position P3, then continues to pass through position P3 and reaches position P4 or position P2 again, it may be said that the trajectory 3 takes a reverse turn relative to trajectory 2 in one round, but the disclosure is not limited to only one round. Two or more reverse turns may also be taken according to the above rules. Further, the turning method of the trajectory does not need to be limited to a round; it may also be in the shape of “8”, as long as the trajectory 3 takes a reverse turn back to the trajectory of position P4 or position P2.

In another embodiment of the disclosure, the phase retardation layer 56 may be located between the light control layer 54 and the first substrate 52, and the principle of the polarization state change is similar to the above-mentioned embodiment, so it will not be repeated.

The trajectory 1, the trajectory 2, the trajectory 3, and the trajectory 4 in FIG. 3 take the phase retardation layer 56 as an example of a negative phase retardation layer. The projection of the second optical axis of the phase retardation layer 56 on the tangent plane of the first substrate 52 and the projection of the first optical axis of the light control layer 54 on the tangent plane of the first substrate 52 are parallel or substantially parallel to each other. Such trajectory 1, trajectory 2, trajectory 3, and trajectory 4 may be controlled relatively accurately, such that the trajectory of the incident light 45 passing through the phase retardation layer 56, for example, the trajectory 3, and the trajectory the light control layer 54, for example, the trajectory 2, are reverse movements of equal or approximately equal length.

It is to be explained here that the trajectory 1, the trajectory 2, the trajectory 3, and the trajectory 4 in FIG. 3 are illustrated by monochromatic light as an example. If more than two colors of light are included at the same time, for example, the incident light includes red light, green light and blue light, because the wavelengths of the light of more than two colors are different, the degree of change in the polarization state of each color light at the light control layer 54 and the phase retardation layer 56 may also be somewhat different. The consideration of lights of different color will be described in more detail later.

FIG. 4 is a schematic diagram of a degree of light leakage according to a certain point at a working area according to a viewing angle position, based on the configuration of FIG. 3, according to an embodiment of the disclosure. Referring to FIG. 4, which takes full-wavelength light, such as the incident light including red light, green light, and blue light, as an example of simulation analysis, the distribution of the transmittance according to the right viewing angle is observed. Low transmittance indicates low light leakage. Angle of sphere surfaces in the radial direction are azimuth angles, and angles of the rounds are elevation angles. A center point may be an angle facing the point, a penetration rate of the angle is the lowest point relative to a penetration rate of other angles. That is, the degree of light leakage at the angle facing the point is not obvious for example. The azimuth angles are illustrated at four corners, for example, at 45 degrees, 135 degrees, 225 degrees, and 315 degrees, but the disclosure is not limited thereto. The area with an elevation angle near 60 degrees has a larger transmittance, and there will be more obvious light leakage, but it is still acceptable. The transmittance is defined as a percentage value of the light intensity after the incident light 45 passes through the second polarization layer 62 and the light intensity before the incident light 45 enters the first polarization layer 50.

The disclosure is not limited to the conditions of FIG. 3. The phase retardation layer 56 may be a positive phase retardation layer, and the change of the polarization state of the positive phase retardation layer lies in taking a forward movement along the trajectory of the light control layer 54.

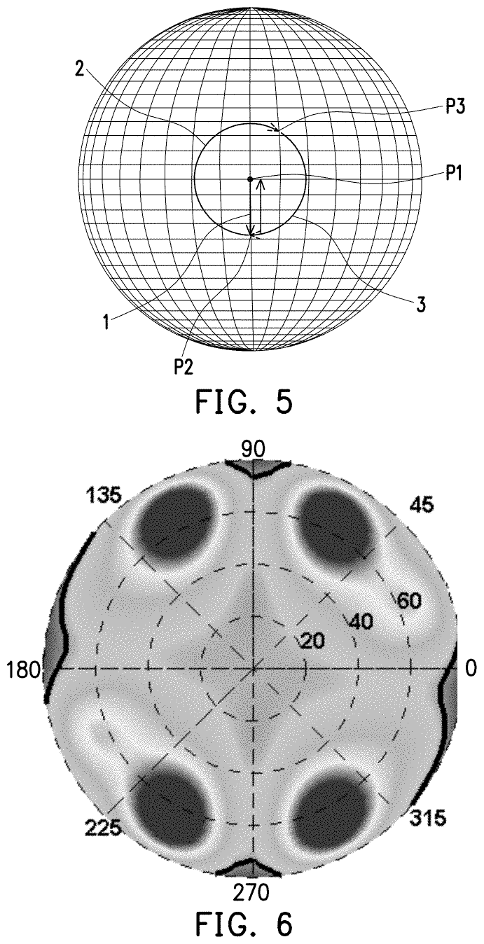

FIG. 5 is a schematic diagram according to an embodiment of the disclosure. FIG. 5 is a schematic diagram of the trajectory of the polarization state on the polarization sphere, in the direction such as the Z direction shown in FIG. 2 of the normal viewing angle at a certain point in the working area, of the monochromatic incident light 45, which may be green, for example, passing through the display panel, according to an embodiment of the disclosure. Referring to FIG. 2 and FIG. 5, in an embodiment, the phase retardation layer 56 may be a positive phase retardation layer, and the positive phase retardation layer may include a positive material with optical anisotropy. The phase retardation layer 56 may include a third optical axis (not shown), and the projection of the third optical axis and the projection of the first optical axis on the tangent plane of the first substrate 52 are parallel to each other. For example, the projection of the first optical axis and the projection of the third optical axis on the tangent plane of the first substrate 52 are both parallel to the X axis.

The changes of the polarization states of the incident light 45 on the trajectory 1 and the trajectory 2 are the same as the change of the polarization state of the incident light 45 shown in FIG. 3, but when the incident light 45 passes through the phase retardation layer 56 of the present embodiment, the polarization change is different. The phase retardation layer 56 may select the suitable phase retardation value, such that the trajectory 3 passes a stop point of the trajectory 2 at position P3, and continues to take a forward movement to reach the stop point of the trajectory 3 at position P2. In other words, the polarization state of the incident light 45 before entering the second substrate 58 is substantially the same as the polarization state of the incident light 45 after passing through the first substrate 52. The same or substantially the same polarization state referred to in the disclosure means that the polarization forms of the incident light are the same or substantially the same. For example, when the polarization state of the incident light 45 before entering the second substrate 58 is a left-circular polarization state, and the polarization state of the incident light 45 after passing through the first substrate 52 is a right-circular polarization state, it may be said that the two polarization states are the same or approximately the same. In this way, the incident light 45 returns to the origin at position P1 after passing through the second substrate 58, that is, it returns to the original polarization state or as close to the original polarization state as possible. When passing through the second polarization layer 62, the incident light 45 is blocked by the second polarization layer 62, effectively reducing light leakage. Here, in a direction of a normal viewing angle, the trajectory 2 on a polarization sphere corresponds to a transition of a polarization state of light passing through the light control layer 54, the trajectory 3 on the polarization sphere corresponds to a transition of a polarization state of the light passing through the positive phase retardation layer 56, and the trajectory 3 may take a forward movement relative to the trajectory 2 and reaches position P2, by may be without round or an integer in trajectory greater than zero.

FIG. 6 is a schematic diagram of a degree of light leakage according to a certain point at a working area in the electronic device 40 according to a viewing angle position, based on the configuration of FIG. 5, according to an embodiment of the disclosure. Referring to FIG. 6, whose coordinates are the same as FIG. 4. FIG. 6 is a simulation analysis of the effect of the embodiment, taking the incident light with full wavelength, for example, the incident light including visible red light, green light, and blue light, as an example. However, the incident light with full wavelength in the visible light range is just an example, other wavelengths may be included. It may be seen from the analysis of FIG. 6 that the front view area at the point still has a low penetration rate relative to other angles. Similar to FIG. 4, areas with azimuth angles of 60 degrees, 120 degrees, 240 degrees, and 300 degrees have greater penetration rates, but the disclosure is not limited thereto. Therefore, the expected effect of reducing light leakage can also be achieved by the disposition of FIG. 5.

In another embodiment of the disclosure, the phase retardation layer 56 may be a positive phase retardation layer. However, the projection of the optical axis of the phase retardation layer 56 on the tangent plane of the first substrate 52 is perpendicular to the projection of the optical axis of the light control layer 54 on the tangent plane of the first substrate 52. For example, the projection of the first optical axis on the tangent plane of the first substrate 52 is parallel to Y axis, and the projection of the optical axis of the phase retardation layer 56 on the tangent plane of the first substrate 52 is parallel to the X axis. Here, in a direction of a normal viewing angle, the trajectory 2 on a polarization sphere corresponds to a transition of a polarization state of a light passing through the light control layer 54, the trajectory 3 on the polarization sphere corresponds to a transition of a polarization state of the light passing through the positive phase retardation layer 56, and trajectory 3 may take a reverse turn relative to the trajectory 2. In such disposition, the change of the polarization state of the incident light of 45 in the trajectory on the polarization sphere is the same as the change of the polarization state of the incident light 45 shown in FIG. 3, and will not be repeated.

The phase retardation layer 56 may be a multi-stacked layer. The position of the phase retardation layer 56 in the overall stacked layer structure is not limited, as long as the polarization state may be reversely or forwardly compensated between the first substrate 52 and the second substrate 58.

The following is an analysis of the trajectory of the polarized state on the polarization sphere, of the incident light 45, with wavelengths of red, green and blue light, for example.

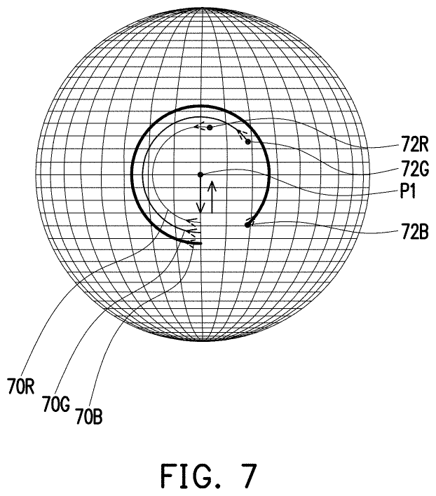

FIG. 7 is a schematic diagram of the trajectories of the polarization states on a polarization sphere of the incident light including red light, blue light, and green light, which pass through the electronic device 40, according to an embodiment of the disclosure. Referring to FIG. 2 and FIG. 7, a trajectory 70 of the polarization state on the polarization sphere of the incident light 45 including red light, green light, and blue light may be divided into a red light trajectory 70R, a green light trajectory 70G, and a blue light trajectory 70B according to different wavelengths. When the incident light 45 passes through the first polarization layer 50, the polarization state at this time is located at position P1 on the polarization sphere. After the incident light 45 passes through the light control layer 54, the red light trajectory 70R, the green light trajectory 70G, and the blue light trajectory 70B respectively stop at the stop point 72R, the stop point 72G, and the stop point 72B stop. At this time, the stop point of red light 72R, the stop point 72G of green light, and the stop point of blue light 72B are dispersed.

If, according to the mechanism of FIG. 3, a negative phase retardation layer is configured as the phase retardation layer 56, in the case of reverse turn, whether the stop point 72R, the top point 72G, and the stop point 72B of the red light trajectory 70R, the green light trajectory 70G, and the blue light trajectory 70B are dispersed, the incident light can substantially return to position P1 after passing through the second substrate 58.

If, according to the mechanism shown in FIG. 5, a positive phase retardation layer is configured as the phase retardation layer 56, in the case of taking a forward movement, after the incident light pass through the second substrate 58, the stop points of the red light trajectory 70R, the green light trajectory 70G, and the blue light trajectory 70B are still dispersed, and not all light can return to position P1. Comparing by the penetration rate in the front view angle, the mechanism according to FIG. 5 has a higher penetration rate than the mechanism according to FIG. 3.

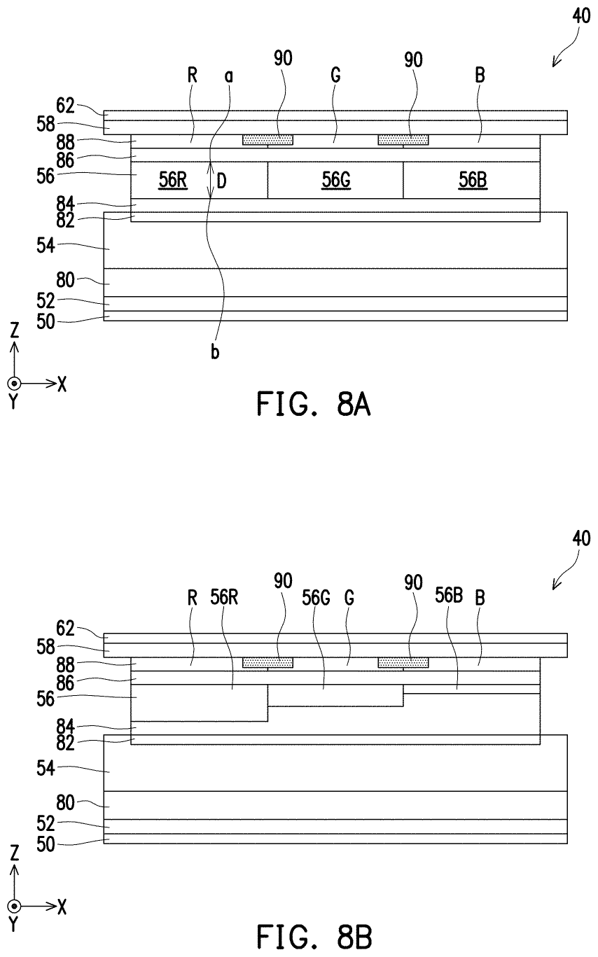

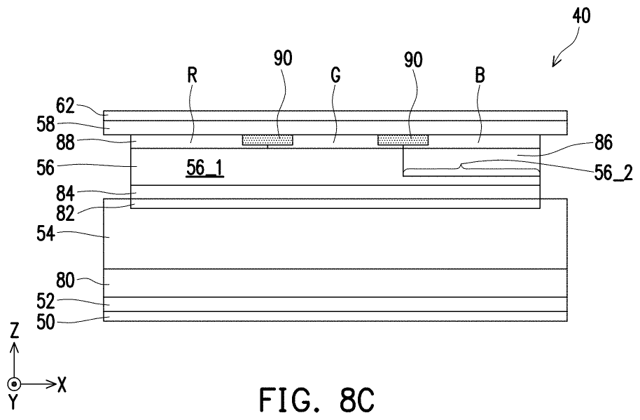

If the mechanism of FIG. 5 is adopted, according to FIG. 2, various compensation methods may be adopted. For example, one or more layers of the compensation film 60 may be disposed between the second substrate 58 and the second polarization layer 62 to compensate for unexpected light leakage. In another embodiment, the compensation film 60 may be disposed above the second polarization layer 62. In yet another embodiment, the structures shown in FIG. 8A to FIG. 8C may be designed to compensate for unexpected light leakage.

FIG. 8A to FIG. 8C are schematic cross-sectional structural diagrams of an electronic device according to various embodiments of the disclosure. Referring to FIG. 8A, in which the electronic device 40 may be, for example, a liquid crystal display device. The liquid crystal display device may include the first polarization layer 50, the first substrate 52, the light control layer 54, the phase retardation layer 56, the second substrate 58, the compensation film 60 (not shown), and the second polarization layer 62. Other layers such as a functional layer 84 and a function layer 86 are added to one or both sides of the phase retardation layer 56, but the disclosure is not limited thereto. Moreover, for example, a polyimide layer (PI) may be added as an alignment film 82 of the light control layer 54, for example, as an alignment film for liquid crystal. Further, the other side of the light control layer may also include other structural layers 80, such as other layers of alignment film. The disclosure is not limited to disposition of various other structural layers. For the actual structure, the liquid crystal display device may also include other components, and a part of the components is also shown in FIG. 8A to FIG. 8C.

A general filter 88 includes, for example, a red filter R, a green filter G, and a blue filter B, which are separated by a black matrix (BM) 90. The phase retardation layer 56 may include a first sub-phase retardation layer 56R, a second sub-phase retardation layer 56G, and a third sub-phase retardation layer 56B. The first sub-phase retardation layer 56R, the second sub-phase retardation layer 56G, and the third sub-phase retardation layer 56B may have the same thickness in terms of geometrical structure. According to some embodiments, the first sub-phase retardation layer 56R, the second sub-phase retardation layer 56G, and the third sub-phase retardation layer 56B may correspond to the red filter R, the green filter G, and the blue filter B. In some embodiments, each sub-phase retardation layer may have their own Δn, which is called the modulated refractive index. By adjusting their respective Δn, the light leakage mechanism caused by different degrees of phase retardation of the incident light having different wavelengths or colors can be reduced. The thickness is defined as a minimum distance between a sub-phase retardation layer being farther from a surface of the filter 88 and extending a center point in the X direction, and the sub-phase retardation layer being closer to the surface of the filter 88 and extending the center point in the X direction. For example, point a and point b in FIG. 8A are the center points of the first sub-phase retardation layer 56R in the X direction, and the minimum distance D between the point a and the point b is the thickness of the first sub-phase retardation layer 56R.

Please refer to FIG. 8B, another embodiment of the disclosure. The phase retardation layer 56, such as a positive phase retardation layer, may include the first sub-phase retardation layer 56R, the second sub-phase retardation layer 56G, and the third sub-phase retardation layer 56B. According to some embodiments, select the Δn (referred to as the modulated refractive index) of each of the first sub-phase retardation layer 56R, the second sub-phase retardation layer 56G, and the third sub-phase retardation layer 56B to be the same or substantially the same; and control the phase retardation value of the incident light after passing through the phase retardation layer 56 by adjusting the thickness. As such, the Δn (referred to as the modulated refractive index) of the phase retardation layer 56 may be the same or substantially the same, but the first sub-phase retardation layer 56R, the second sub-phase retardation layer 56G, and the third sub-phase retardation layer 56B are different in thickness. In the present embodiment, the functional layer 84 may compensate for the uneven thickness of the phase retardation layer 56 to make the structure close to a flat structure.

Referring to FIG. 8C, the phase retardation layer 56 may include two parts: a phase retardation layer 56_1 and a phase retardation layer 56_2. Referring to FIG. 7, since the distance between the 72R and the 72G is smaller than the distance between any one of the two and the stop point B after the light passes through, for example, the light control layer 54, the same phase retardation layer 56_1 is adopted for the places corresponding to the red filter R and the green filter G, but the thickness of the phase retardation layer 56_2 corresponding to the blue filter B, as shown in FIG. 8C, will be thinner. In the present embodiment, the functional layer 86, for example, is used to compensate the thickness.

It should also be noted here that some of the embodiments may also be combined with each other, and the disclosure is not limited to individual embodiment.

The disclosure proposes to dispose the phase retardation layer between two substrates. When the birefringent material of the substrate or when two substrates are curved, causing the axes of the two substrates to be perpendicular to each other, the phase retardation layer may compensate for the polarization state generated by the light control layer in the reverse or forward direction, such that the trajectory can move in an integer round relative to the starting point on the polarization sphere, for example, without round or in one round. The phase retardation layer includes a birefringent material. The optical axis included in the birefringent material may be, for example, the slow optical axis, which may be parallel or perpendicular to the projection of the optical axis of the light control layer on the tangent plane of the substrate.

Although the embodiments of the disclosure and their advantages have been disclosed as above, it should be understood that any person with ordinary knowledge in the relevant technical field can make changes, substitutions and modifications without departing from the spirit and scope of the disclosure. In addition, the scope of protection of the disclosure is not limited to the manufacturing process, machinery, manufacturing, material composition, device, method, and steps in the specific embodiments described in the specification. Anyone with ordinary knowledge in the technical field can disclose the content from this disclosure. It is understood that the current or future developed processes, machines, manufacturing, material composition, devices, methods and steps can be used according to the disclosure as long as they can implement substantially the same functions or obtain substantially the same results in the embodiments described herein. Therefore, the protection scope of the disclosure includes the above-mentioned manufacturing processes, machines, manufacturing, material composition, devices, methods, and steps. In addition, each claim constitutes an individual embodiment, and the protection scope of this disclosure also includes the combination of each claim and embodiment. The scope of protection of this disclosure shall be defined by the appended claims.

What is claimed is:

1. An electronic device, comprising:
a first substrate;
a second substrate, disposed opposite to the first substrate;
a light control layer, disposed between the first substrate and the second substrate, the light control layer comprising a first optical axis; and
a negative phase retardation layer, disposed between the first substrate and the second substrate, the negative phase retardation layer comprising a second optical axis,
wherein a projection of the first optical axis on a tangent plane of the first substrate and a projection of the second optical axis on the tangent plane of the first substrate are parallel to each other.

2. The electronic device according to claim 1, wherein in a direction of a normal viewing angle, a first trajectory on a polarization sphere corresponds to a transition of a polarization state of light passing through the light control layer, a second trajectory on the polarization sphere corresponds to a transition of a polarization state of the light passing through the negative phase retardation layer, and the second trajectory takes a reverse turn relative to the first trajectory.

3. The electronic device according to claim 2, wherein the reverse turn that the second trajectory takes relative to the first trajectory is without round or an integer round in trajectory greater than zero.

4. The electronic device according to claim 2, further comprising a polarization layer and a compensation film disposed between the second substrate and the polarization layer.

5. The electronic device according to claim 2, wherein a phase retardation value of the negative phase retardation layer is substantially equal to the light control layer minus an integer multiple of a wavelength of the light, and the integer is greater than or equal to zero.

6. The electronic device according to claim 1, the electronic device is a liquid crystal display device.

7. The electronic device according to claim 1, wherein an optical axis of the first substrate and an optical axis of the second substrate are perpendicular to each other.

8. An electronic device, comprising:
a first substrate;
a second substrate, disposed opposite to the first substrate;
a light control layer, disposed between the first substrate and the second substrate, the light control layer comprising a first optical axis; and
a positive phase retardation layer, disposed between the first substrate and the second substrate, the positive phase retardation layer comprising a third optical axis,
wherein a projection of the first optical axis on a tangent plane of the first substrate and a projection of the third optical axis on the tangent plane of the first substrate are parallel to each other.

9. The electronic device according to claim 8, wherein in a direction of a normal viewing angle, a first trajectory on a polarization sphere corresponds to a transition of a polarization state of light passing through the light control layer, a second trajectory on the polarization sphere corresponds to a transition of a polarization state of the light passing through the positive phase retardation layer, and the second trajectory takes a forward movement continuing the first trajectory.

10. The electronic device according to claim 9, wherein the forward movement that the second trajectory takes continuing the first trajectory may be without round or an integer round in trajectory greater than zero.

11. The electronic device according to claim 8, further comprising a polarization layer and a compensation film disposed between the second substrate and the polarization layer.

12. The electronic device according to claim 9, wherein a polarization state of the light before entering the second substrate is substantially the same as a polarization state of the light after passing through the first substrate.

13. The electronic device according to claim 8, wherein the electronic device is a liquid crystal display device.

14. The electronic device according to claim 8, wherein an optical axis of the first substrate and an optical axis of the second substrate are perpendicular to each other.

15. An electronic device, comprising:
a first substrate;
a second substrate, disposed opposite to the first substrate;
a light control layer, disposed between the first substrate and the second substrate, the light control layer comprising a first optical axis; and
a positive phase retardation layer, disposed between the first substrate and the second substrate, the positive phase retardation layer comprising a third optical axis,
wherein a projection of the first optical axis on a tangent plane of the first substrate and a projection of the third optical axis on the tangent plane of the first substrate are perpendicular to each other.

16. The electronic device according to claim 15, wherein in a direction of a normal viewing angle, a first trajectory on a polarization sphere corresponds to a transition of a polarization state of a light passing through the light control layer, a second trajectory on the polarization sphere corresponds to a transition of a polarization state of the light passing through the positive phase retardation layer, and the second trajectory takes a reverse turn relative to the first trajectory.

17. The electronic device according to claim 16, wherein the reverse turn that the second trajectory takes relative to the first trajectory may be without round or an integer round in trajectory greater than zero.

18. The electronic device according to claim 15, further comprising a polarization layer and a compensation film disposed between the second substrate and the polarization layer.

19. The electronic device according to claim 16, wherein a polarization state of the light before entering the second substrate is substantially the same as a polarization state of the light after passing through the first substrate.

20. The electronic device according to claim 15, wherein the positive phase retardation layer comprises a first sub-phase retardation layer, a second sub-phase retardation layer and a third sub-phase retardation layer, and the first sub-phase retardation layer, the second sub-phase retardation layer and the third sub-phase retardation layer are different in thickness.
